(19) United States
(12) Patent Application Publication
(10) Pub. No.: US 2003/0072028 A1
(43) Pub. Date: Apr. 17, 2003

(54) Image forming devices and methods of forming hard images

(76) Inventors: Robert E. Haines, Boise, ID (US); Judith A. Garzolini, Star, ID (US)

Correspondence Address: HEWLETT-PACKARD COMPANY, Intellectual Property Administration, P.O. Box 272400, Fort Collins, CO, 80527-2400, US

(21) Appl. No.: 09/981,117

(22) Filed: Oct. 17, 2001

(51) Int. Cl. G06F 3/12; G06F 11/00

(52) U.S. Cl. 358/1.15; 710/15

(57) ABSTRACT

Image forming devices and methods of forming hard images are provided. According to one aspect, an image forming device includes a housing including a media path arranged to guide media; a sensor configured to obtain encoded data from the media and to output a signal indicative of the encoded data; and imaging circuitry configured to form hard images upon the media, to receive the signal and to perform at least one function with respect to the formation of the hard images within the image forming device responsive to the encoded data indicated within the signal.

### FIELD OF THE INVENTION

This invention relates to image forming devices and methods of forming hard images.

### BACKGROUND OF THE INVENTION

Systems and methods relating to document generation have experienced advancements in both host device configurations, such as personal computers, and imaging devices, such as printers. Personal computers operate at faster processing rates with increased storage capacities while imaging devices provide tremendous resolution, color capabilities, and enhanced imaging speeds, for example.

In addition, printers are provided with numerous accessories (e.g., plural media trays, envelope feeders, etc.) which enable a printer to image upon numerous types of media. Printers with such flexibility with respect to different media types have enjoyed great popularity with users.

However, typical configurations involve manual processes of identifying respective supplies and loading the correct media type into the appropriate supply or feeder by hand. If incorrect media is loaded into a device, conventional devices are typically not configured to detect the mistake, and proceed to form images upon the improper media. As a result, the job may need to be reimaged upon correct media, or parts of the printer replaced if, for example, incompatible media melts to printer assemblies or otherwise renders such assemblies unusable.

There exists a need to provide improved imaging devices and methodologies.

### SUMMARY OF THE INVENTION

The invention provides image forming devices and methods of forming hard images.

According to a first aspect, an image forming device comprises: a housing including a media path arranged to guide media; a sensor configured to obtain encoded data from the media and to output a signal indicative of the encoded data; and imaging circuitry configured to form hard images upon the media, to receive the signal and to perform at least one function with respect to the formation of the hard images within the image forming device responsive to the encoded data indicated within the signal.

Another aspect of the invention provides an image forming device comprising: a housing including a media path arranged to guide media; an interface configured to implement communications externally of the image forming device; a plurality of media supplies individually configured to supply sheet media having encoded data; a plurality of first sensors individually associated with a respective one of the media supplies and configured to obtain encoded data from the respective media and to output a signal indicative of the encoded data; a second sensor configured to monitor at least one ambient condition within the environment of the image forming device and to output a signal indicative of the at least one ambient condition; an image engine configured to print hard images upon the media according to an imaging parameter; storage circuitry configured to store a plurality of settings for the imaging parameter and corresponding to a plurality of respective media types; and control circuitry configured to access at least one setting from the storage circuitry responsive to the signals from at least one of the first sensors and the second sensor and to control adjustment of the imaging parameter responsive to the at least one setting, and to generate a message identifying a brand and type of media, and to apply the message to the interface for communication to a host device coupled with the interface to display the brand and the type of media using the host device.

Yet another aspect of the invention provides a method of forming hard images comprising: moving media along a media path of an image forming device; forming hard images upon the media using the image forming device; retrieving encoded data from the media using the image forming device; and performing at least one function with respect to the media using the image forming device responsive to the encoded data.

Other features and advantages of the invention will become apparent to those of ordinary skill in the art upon review of the following detailed description, claims, and drawings.

### DESCRIPTION OF THE DRAWINGS

FIG. 1 is an illustrative representation of an image forming system.

FIG. 2 is a cross-sectional view of an exemplary image forming device of the image forming system.

FIG. 3 is a functional block diagram depicting exemplary components of the image forming device.

FIG. 4 is an exemplary screen display of a host device of the image forming system.

FIG. 5 is a flow chart depicting an exemplary methodology executable within the image forming device.

### DETAILED DESCRIPTION OF PREFERRED EMBODIMENTS

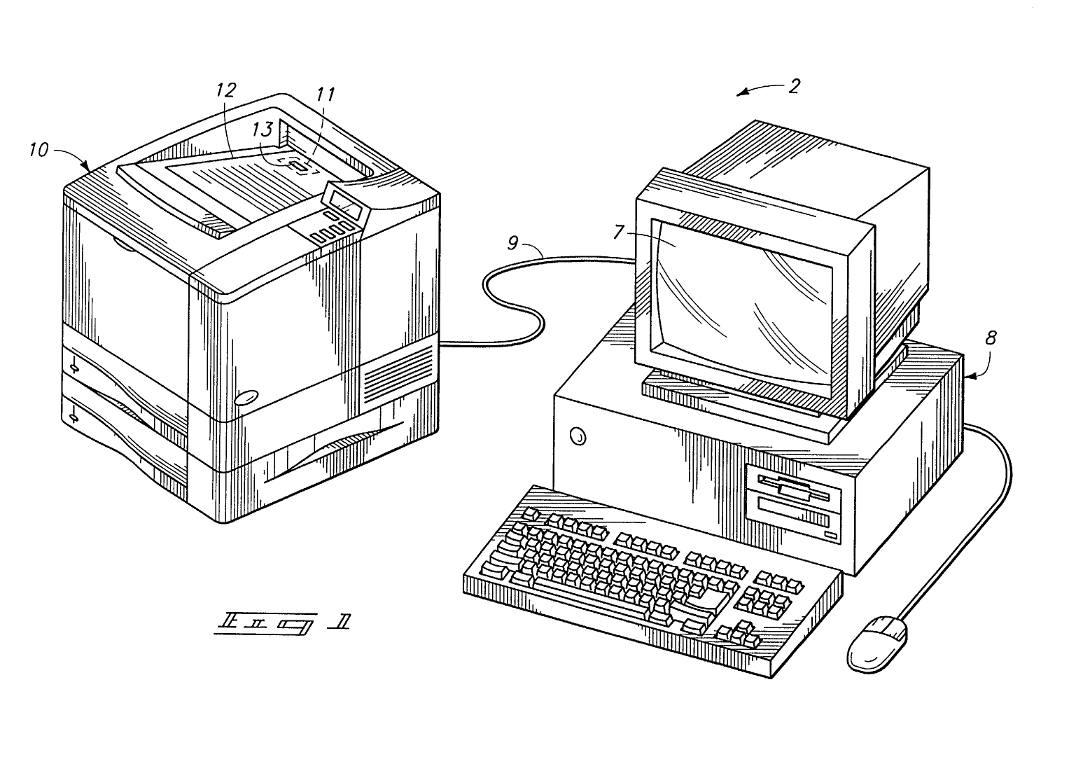

Referring to FIG. 1, an exemplary image forming system 2 includes a host device 8, an image forming device 10 and a communication medium 9 coupling host device 8 with image forming device 10.

Host device 8 is implemented as a personal computer (PC), server, Web server, or other device configured to communicate with image forming devices 10. Host device 8 includes a display 7, such as a CRT or flat panel monitor, to display information to a user.

An exemplary communication medium 9 includes a parallel connection, packet switched network, such as an Intranet network (e.g., Ethernet arrangement), and/or Internet, and other communication configurations operable to provide electronic exchange of information between host device 8 and image forming device 10, using an appropriate protocol. Other image forming system arrangements are possible including additional host devices 8 and/or additional image forming devices 10 coupled with communication medium 9, such as in a network arrangement for example.

Image forming device 10 is configured to form hard images upon media 12. One exemplary image forming device 10 comprises a printer, such as a laser printer, ink jet printer, a dot matrix printer, or a dry medium printer. The present invention is embodied within other image forming device configurations such as multiple function peripheral devices, copiers, facsimile machines, plotters, etc. or other arrangements configured to form hard images upon media 12 according to alternative embodiments of the invention. Device 10 is arranged to form hard images upon media 12 including, for example, paper, envelopes, transparencies, labels, etc.

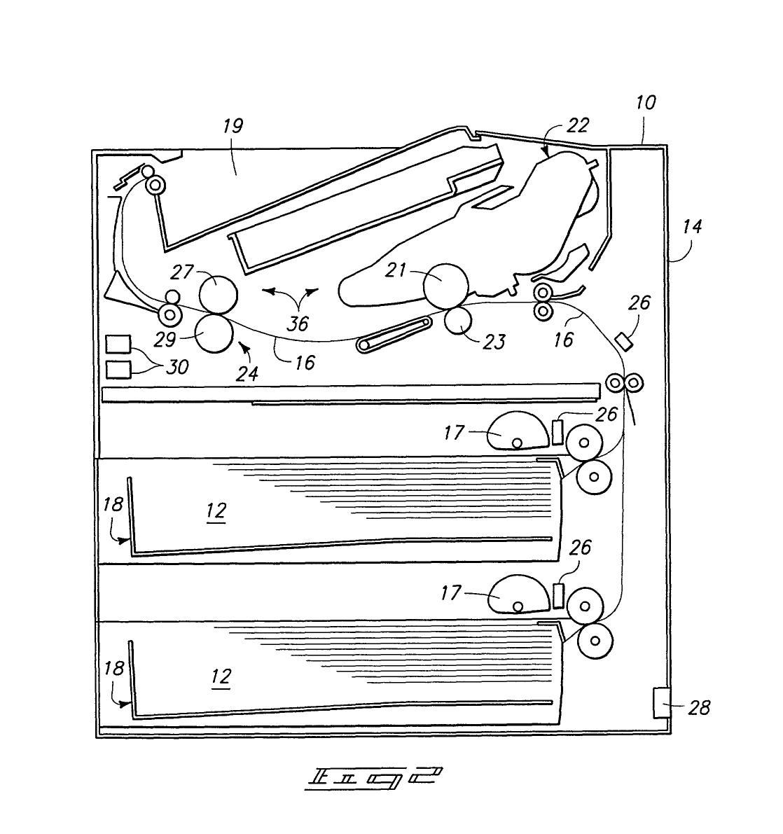

Referring to FIG. 2, further details of an exemplary arrangement of image forming device 10 are shown. Depicted image forming device 10 includes a housing 14 arranged to define a media path 1 6 to guide media within housing 14. For example, a plurality of rollers are arranged within housing 14 to define media path 16 and to direct media 12 from one or more media supply 18 to an output tray 19.

In the depicted arrangement, device 10 includes a plurality of media supplies 18 individually configured to supply a desired type of media 12, some or all which have encoded data 13 thereon. The encoded data 13 (FIG. 1) includes media identification information, such as brand and type information (e.g., “Hewlett-Packard”, “Bright White”, “SoftGloss”, etc.) and/or information usable by device 10 to form hard images upon such media 12 (e.g., imaging parameter settings as described below). Encoded data 13 is read from media 12 by sensors in the described embodiment and described in further detail below.

Exemplary media supplies 18 include paper trays configured to supply different types of sheet-fed media 12 (e.g., discrete sheets of paper). Other types of media are possible for provision in supplies 18 including, for example, envelopes, transparencies, labels as well as media of different types, such as letterhead, laser, glossy, roll-fed media or having other characteristics. Media supplies 18 include respective pick rollers 17 as shown arranged to retrieve media from respective supplies 18.

The depicted image forming device 10 further includes an image engine 36 adjacent media path 16 and arranged to print or otherwise form hard images upon media 12. An exemplary image engine 36 comprises a print engine including a developing assembly 22 and a fusing assembly 24 in the depicted embodiment. Control circuitry (not shown in FIG. 2) discussed below is configured to control operations of device 10 including controlling operations of developing and fusing assemblies 22, 24 as described in further detail below.

Developing assembly 22 is positioned adjacent media path 16 and provides developing material, such as toner, for forming images. Developing assembly 22 is implemented as a disposable cartridge for supplying such developing material in one configuration. In the illustrated arrangement, developing assembly 22 includes an imaging roller 21 and transfer roller 23. Imaging roller 21 is a photo conductor or photosensitive drum which is insulative in the absence of incident light and conductive when illuminated. Imaging roller 21 may be implemented as a belt in an alternative configuration. A media sheet (not shown in FIG. 2) traveling along media path 16 passes intermediate imaging roller 21 and transfer roller 23. A developed image comprising developing material is transferred to media sheet within a transfer nip defined by rollers 21, 23. A bias voltage is applied to transfer roller 23 positioned below the passing media sheet to induce an electric field through the media sheet.

Fusing assembly 24 is adjacent media path 16 and is located downstream from imaging assembly 22 within image forming device 10. Fusing assembly 24 fuses the developing material corresponding to the image to the media. Fusing assembly 24 includes a fusing roller 27 and a pressure roller 29. Media sheets pass intermediate fusing roller 27 and pressure roller 29 at a fuser nip. Fusing roller 27 preferably includes an internal heating element (not shown) to impart heat flux to developing material upon media sheet as well as the media sheet itself. Application of such heat flux from fusing roller 27 fuses developing material cohesively to media sheet forming hard images.

According to aspects of the present invention, image forming device 10 includes one or more sensor configuration 26 configured to obtain or retrieve encoded data 13 from media 12 (shown in FIG. 1) and to output a signal indicative of the encoded data. Plural configurations of sensors 26 are possible depending upon the type of media 12 being utilized and the form of encoded data 13 thereon as described further below.

For example, according to a first embodiment, sensors 26 are configured to monitor encoded data 13 in the form of coded indicia (e.g., bar code not within the visible spectrum) stored upon respective sheets of media 12. An exemplary configuration of such a sensor configuration is described in U.S. Pat. No. 6,047,1 10 to Smith, assigned to the assignee hereof, and incorporated herein by reference.

Another exemplary configuration of sensor 26 is arranged to implement radio frequency communications as described in U.S. Pat. No. 6,107,920 to Eberhardt et al., incorporated herein by reference. For example, encoded data 13 is embedded within a communication device implemented with respect to reams of media 12 within respective media supplies 18 or with respect to sheets of media 12 individually (an exemplary such device 11 is depicted embedded in media 12 in FIG. 1). Sensors 26 are configured to communicate with such communication devices 11 and receive embedded information comprising the encoded data 13 therefrom. Other configurations of sensors 26 are possible.

In another exemplary configuration, media 12 comprising for example a transparency, may have a leading heading header portion (e.g., white strip) which includes the encoded data 13. Sensor 26 is configured to obtain the encoded data 13 from the appropriate header if provided.

In one exemplary configuration, sensors 26 are positioned and provided to monitor respective media supplies 18 as well as media 12 at an appropriate position along media path 16 as shown in FIG. 2. Alternatively, sensors 26 are provided at one of the locations adjacent media supplies 18 or along media path 16. In further configurations (not shown), sensors 16 are located at other desired positions to monitor media 12 and encoded data thereon.

According to further aspects of the present invention, additional sensors 30 are provided to monitor at least one ambient condition within the environment of image forming device 10. Such sensors 30 are configured to output signals indicative of the at least one ambient condition. In exemplary configurations, sensors 30 are operable to monitor temperature, humidity and/or other ambient conditions about image forming device 10. The ambient conditions may be utilized in combination with information retrieved from media 12 to adjust imaging parameters discussed below.

Image forming device 10 includes an interface 28 configured to couple with communication medium 9 for implementing communications externally of device 10 with host device 8 or other external device. Interface 28 receives image data from communication medium 9 and device 10 subsequently forms images upon media 12 using image data received via interface 28. Interface 28 is implemented as a JetDirect(tm) card available from Hewlett-Packard Company in one configuration.

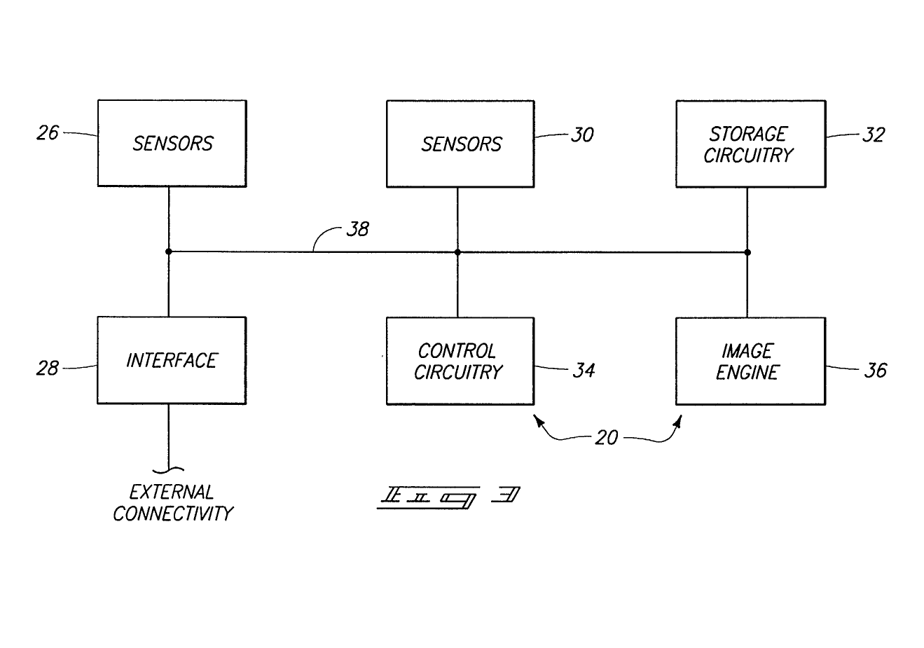

Referring to FIG. 3, exemplary electrical components of image forming device 10 arranged to implement and to control operations of image forming device 10 are shown. The depicted electrical circuitry of image forming device 10 includes sensors 26, interface 28, sensors 30, storage circuitry 32 and imaging circuitry 20 (imaging circuitry 20 includes control circuitry 34 and image engine 36 comprising assemblies 22, 24, in the described exemplary embodiment). Further, a communication medium 38 configured to implement appropriate communications is provided intermediate internal components of image forming device 10. In one arrangement, communication medium 38 is implemented as a bidirectional bus.

Storage circuitry 32 is configured to store electrical information such as image data for usage in formulating hard images and instructions usable by control circuitry 34 for implementing image forming operations within device 10. Exemplary storage circuitry 32 includes nonvolatile memory (e.g., EEPROM, flash memory and/or read only memory (ROM)), random access memory (RAM) and hard disk and associated drive circuitry.

An exemplary configuration of control circuitry 34 is implemented as a processor, such as a dedicated microprocessor, configured to execute software and/or firmware executable instructions. Control circuitry 34 implements processing of image data (e.g., rasterization) received via interface 28.

Further, control circuitry 34 of imaging circuitry 20 performs functions with respect to the formation of hard images including controlling operations of image engine 36 comprising developing assembly 22 and fusing assembly 24 in the described embodiment. For example, control circuitry 34 obtains data via appropriate signals from one or more of sensors 26, 30 and adjusts imaging parameters of image engine 36 during formation of hard images as further described below.

As described also below and in accordance with other aspects, control circuitry 34 is arranged to perform the function of formulating messages for communication externally of image forming device 10 to assist with the formation of hard images using device 10.

Device 10 including image engine 36 is configured to form hard images upon media 12 according to one or more imaging parameter. Exemplary imaging parameters include media speed along media path 16, developing settings such as amounts of toner or ink, bias voltages, etc. and fusing operations such as fusing temperatures controlled by the heating elements within fusing assembly 24. Control circuitry 34 is capable of controlling some or all imaging parameters within device 10 subject to adjustment to effect formation of hard images upon media 12 in the described configuration of device 10 and responsive to the encoded data 13 from media 12.

In accordance with aspects of the present invention, it is preferred to configure image forming device 10 according to the type of media being imaged upon. Different types of media 12 have various weights, surface finishes, roughness, wicking properties, etc. which impact the quality of images formed thereupon. Imaging parameters of device 10 including image engine 36 are adjusted by control circuitry 34 to optimize the formation of quality images upon media 12 responsive to the types of media utilized as indicated by encoded data 13 according to aspects of the present invention.

In one configuration, storage circuitry 32 is configured to store a plurality of settings for one or more imaging parameter corresponding to a plurality of respective media types. Such can be implemented, for example, in a look-up table within storage circuitry 32. Upon identification of media 12 using encoded data 13 detected by sensors 26, the appropriate imaging parameter settings are obtained and used by control circuitry 34 for configuring device 10.

Alternatively, the appropriate imaging parameter settings are provided within encoded data 13 retrieved from media 12. The imaging parameter settings may be used directly to configure device 10 or for providing initial settings which may be subsequently modified based upon information from sensors 30 or other information to optimize imaging. For example, an imaging parameter setting may be initially set according to encoded data 13 and subsequently changed corresponding to data from sensors 30 to optimize imaging.

According to other aspects, information from sensors 30 is used to select appropriate settings within the encoded data 13 or from storage circuitry 32. For example, a plurality of imaging parameter settings may be offered for one imagining parameter for a given type of media. One of the plurality of settings may be selected by control circuitry 34 using data from sensors 30 (e.g., data regarding temperature or humidity) or other data in the exemplary embodiment. In sum, control circuitry 34 uses information from both sensors 26, 30 to optimize settings of imaging parameters.

As stated previously and in accordance with additional aspects, for example, control circuitry 34 is arranged to implement and monitor operations of device 10. Encoded data 13 includes an identifier for the respective sheet of media 12 in one configuration and control circuitry 32 is configured to detect via a sensor 26 that the sheet has already been imaged upon (e.g., second feed or duplex operation) using for example, a history of sheets imaged upon stored in storage circuitry 32. Thereafter, control circuitry 34 can adjust imaging parameter settings for optimization responsive to indicated previous imaging upon media 12.

In accordance with additional aspects, device 11 receives information communicated from a sensor 26 to record therein which sides of media 13 have been imaged upon and the number of times such imaging has occurred per side. Sensor 26 recalls the stored information from the given sheet of media 13 at a subsequent moment in time (e.g., during a subsequent imaging operation of the same sheet media 12) to adjust imaging parameter settings inasmuch as previous imaging may impact or affect subsequent imaging for a given sheet of media 13.

Further, in other embodiments, encoded data 13 includes settings for various surfaces of media 13. Control circuitry 34 adjusts imaging parameter settings based upon imaging upon a front, back or possibly side surface of media 13 as detected by sensor 26 adjacent media path 16.

Storage circuitry 32 initially contains a plurality of initial settings for imaging parameters and respective types of media 12 provided within device 1 0. At subsequent moments in time, it may be desired to update the settings corresponding to different types of media 12 provided within device 10. Host device 8 is operable to forward via interface 28 replacement or updated imaging parameter settings at a subsequent moment in time corresponding to the media 12 within device 10. Alternatively, device 11 communicates replacement settings to a sensor 26 for storage in storage circuitry 32. Storage circuitry 32 stores the replacement settings for future access.

According to other aspects of the invention, control circuitry 34 is operable to halt imaging operations within device 10 or prevent formation of images upon the detection of certain types of media 12. For example, it is undesirable to utilize an improper type of media 12 within image forming device 10 (e.g., utilizing an ink jet transparency within device 10 configured as a laser printer may result in destruction of the fusing assembly thereof). Accordingly, upon detection of an incompatible type of media 12 using encoded data 13, control circuitry 34 prevents formation of images thereon or otherwise halts imaging operations.

According to further aspects of the present invention and as mentioned above, control circuitry 34 of image circuitry 20 generates messages identifying types of media 12 available within media supplies 18 responsive to encoded data 13 retrieved from media 12. Control circuitry 34 operates to apply messages to interface 28 for communication to host device 8 or other external device coupled with interface 28.

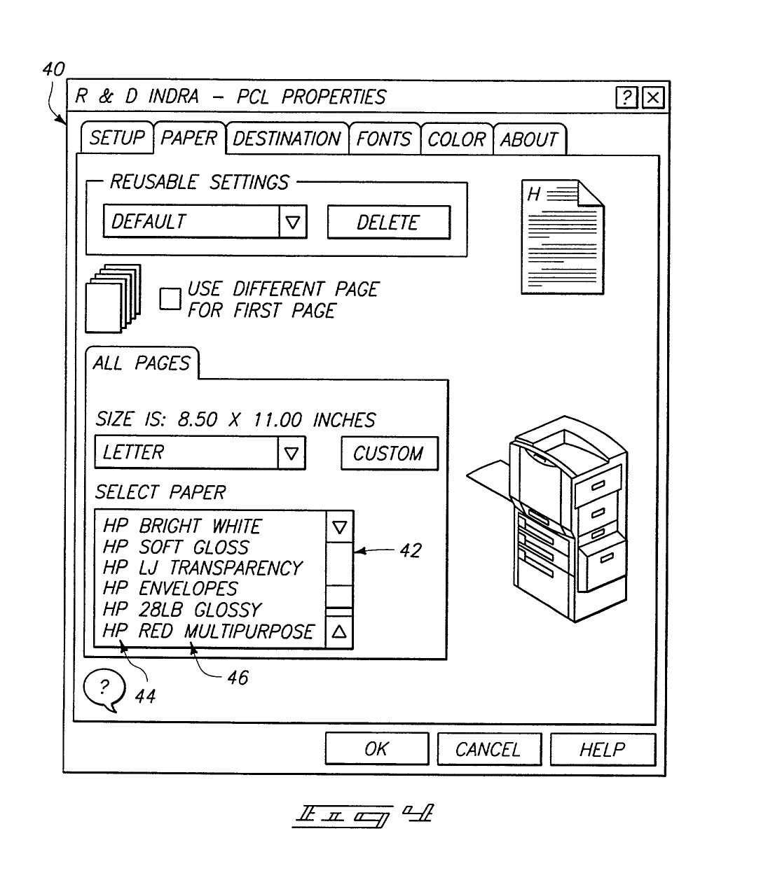

Host device 8 displays information received within the messages to a user in any appropriate method, such as using a screen display. An exemplary screen display is shown in FIG. 4 and described below. According to aspects of the present invention, the generated message communicated from image forming device 10 identifies the type and brand of media for display within host device 8 which is conveyed to a user. Image forming device 10 detects media information from encoded data 13 provided within media 12 and forwards the obtained information regarding the media within a message or other appropriate format to host device 8 operable to depict the media information. Host device 8 depicts the media information in a convenient arrangement, such as using screen display 40 described below.

According to additional aspects of the present invention, control circuitry 34 is configured to generate the message comprising an order to assist with replenishment of media 12. Control circuitry 34 formulates the message to include an appropriate identifier to assist with replenishment of the media, such as a uniform resource locator (URL), e-mail message, or other supplier identifier may assist with replenishment of media 12. A user of host device 8 then forwards the received message comprising an order to the appropriate supplier as identified by the supplier identifier to replenish the media 12. Further description of formulation of an order is described in a U.S. Patent Application entitled “Image Forming Devices And Methods of Facilitating Ordering of an Imaging Consumable” having attorney docket 10003222-1, naming Robert E. Haines and Mark A. Harper as inventors, assigned to the Assignee of the present invention, and incorporated herein by reference.

Referring to FIG. 4, an exemplary screen display 40 corresponding to a print driver application is depicted. Other applications are possible. According to aspects of the present invention, host device 8 is arranged to depict screen display 40 via display 7. Host device 8 includes a processor (not shown) configured to execute executable code to depict the illustrated screen display 40.

As shown, screen display 40 is implemented as a graphical user interface (GUI) operable to display status information with respect to image forming device 10 as well as to implement control of operations of image forming device 10 responsive to user input via for example, a key board or mouse. The illustrated screen display 40 is depicted during execution of a user application via host device 8, such as an application used to formulate hard images (e.g., word processor, spreadsheet, etc.).

The depicted screen display 40 includes a list box 42 arranged to depict a plurality of available types of media with respect to image forming device 10. Such is usable to depict brand information 44 as well as media type information 46. Using list box 42, a user of host device 8 monitors the current selection of media and may affirmatively select new or other appropriate media 12 for formation of images. Such can be selected for a given page or an entire document. For example, a user selects one type of media using list box 42 for the front and back pages, and another type of media for intermediate pages.

As described above, sensors 26 associated with respective media supplies 18 identify media 13 associated with supplies 18. Such identification information of media 13 in respective supplies 18 may be communicated to host device 8 for depiction within screen display 40 (e.g., the screen display is configured according to other aspects to depict media associated with individual supplies 18). Further, sensor 26 could indicate absence of media 13 from a respective supply 18 by failing to detect encoded data 13 of media 13. A message is formulated by control circuitry 34 for communication to host device 8 to indicate to a user the absence of the respective media 13 indicating a need for replacement.

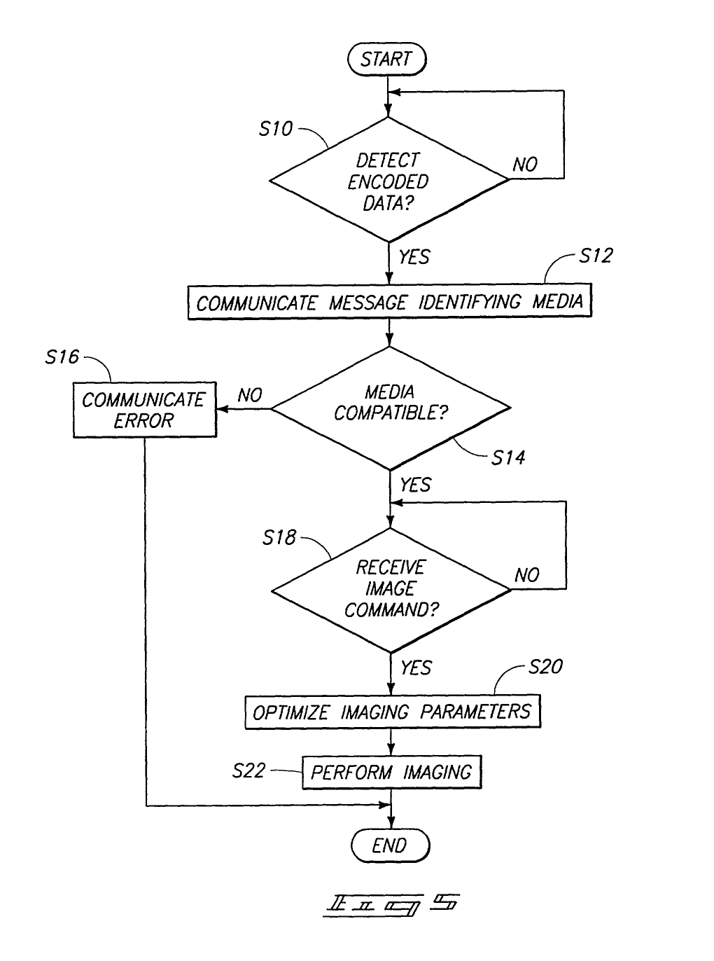

Referring to FIG. 5, an exemplary methodology executable within image forming device 10 is shown. The depicted methodology is implemented as a series of ordered executable instructions stored within storage circuitry 32 in the described embodiment and which are presented to control circuitry 34 for execution. In other alternative configurations, the depicted methodology is implemented in hardware. The methodology of FIG. 5 depicts a plurality of aspects of the present invention. Individual ones of the depicted aspects and other aspects are implemented in one or more other respective executable methodology (not shown) in accordance with other arrangements of the present invention.

In accordance with the depicted methodology, control circuitry 34 proceeds to a step S10 to determine whether appropriate encoded data has been detected within media 12 using sensors 26.

If not, control circuitry 34 idles at step S10 or performs other steps not shown.

Otherwise, control circuitry 34 proceeds to a step S12 to generate and communicate a message identifying the media 12 to interface 28 for communication externally of image forming device 10, such as communicated to host device 8 as described above. The message may be configured as an order if appropriate to assist with replenishment of the media.

At a step S14, control circuitry 34 determines whether the detected media is compatible for usage within image forming device 10.

If not, control circuitry 34 proceeds to step S16 and formulates an appropriate error message and communicates the appropriate error message to interface 28 for communication to host device 8. Further, control circuitry 34 will not perform imaging upon the detected incompatible media according to aspects of the present invention.

If the condition of step S14 is in the affirmative, control circuitry 34 proceeds to a step S18. At step S18, control circuitry 34 determines whether an image command has been received from host device 8.

If not, control circuitry 34 idles at step S18.

Responsive to the condition of step S18 being in the affirmative, control circuitry 34 proceeds to a step S20 to optimize or otherwise adjust appropriate imaging parameter settings corresponding to the detected media 12. Exemplary optimization includes using detected ambient conditions as described above to control adjustment of imaging parameters.

At a step S22, control circuitry 34 implements imaging operations comprising formation of hard images upon media 12 using the appropriate imaging engine and in accordance with the proper imaging parameter settings.

The protection sought is not to be limited to the disclosed embodiments, which are given by way of example only, but instead is to be limited only by the scope of the appended claims.

What is claimed is:

1. An image forming device comprising:
a housing including a media path arranged to guide media;
a sensor configured to obtain encoded data from the media and to output a signal indicative of the encoded data; and
imaging circuitry configured to form hard images upon the media, to receive the signal and to perform at least one function with respect to the formation of the hard images within the image forming device responsive to the encoded data indicated within the signal.

2. The image forming device in accordance with claim 1 wherein the sensor is configured to obtain the encoded data from the media comprising a plurality of discrete sheets.

3. The image forming device in accordance with claim 1 wherein the imaging circuitry is configured to form the hard images upon the media according to an imaging parameter and to perform the at least one function comprising adjusting the imaging parameter.

4. The image forming device in accordance with claim 3 further comprising another sensor configured to monitor at least one ambient condition within the environment of the image forming device and to out put a signal indicative of the at least one ambient condition, and wherein the imaging circuitry is configured to adjust the imaging parameter responsive to the signal from the another sensor.

5. The image forming device in accordance with claim 3 further comprising:
storage circuitry configured to store a plurality of initial settings for the imaging parameter and corresponding to a plurality of media types, and wherein the imaging circuitry is configured to access at least one of the settings responsive to the encoded data identifying the media; and
an interface configured to receive updated settings and wherein the storage circuitry is configured to store the updated settings to replace the initial settings.

6. The image forming device in accordance with claim 1 further comprising an interface configured to implement communications externally of the image forming device, and wherein the imaging circuitry is configured to perform the at least one function comprising generating a message identifying the media, and applying the message to the interface for communication to a host device coupled with the interface.

7. The image forming device in accordance with claim 6 wherein the generating the message comprises generating the message to identify the type and the brand of media for display using the host device.

8. The image forming device in accordance with claim 6 wherein the message comprises an order to assist with replenishment of the media.

9. The image forming device in accordance with claim 1 wherein the imaging circuitry is configured to perform the at least one function comprising preventing formation of hard images upon the media.

10. The image forming device in accordance with claim 1 further comprising:
a plurality of media supplies individually configured to supply a given type of media individually having encoded data; and
an additional sensor, wherein the sensors are individually associated with a respective one of the media supplies and configured to obtain encoded data from the respective media and to output a signal indicative of the encoded data.

11. The image forming device in accordance with claim 1 wherein the imaging circuitry is configured to print hard images upon media.

12. An image forming device comprising:
a housing including a media path arranged to guide media;
an interface configured to implement communications externally of the image forming device;
a plurality of media supplies individually configured to supply sheet media having encoded data;
a plurality of first sensors individually associated with a respective one of the media supplies and configured to obtain encoded data from the respective media and to output a signal indicative of the encoded data;
a second sensor configured to monitor at least one ambient condition within the environment of the image forming device and to output a signal indicative of the at least one ambient condition;
an image engine configured to print hard images upon the media according to an imaging parameter;
storage circuitry configured to store a plurality of settings for the imaging parameter and corresponding to a plurality of respective media types; and
control circuitry configured to access at least one setting from the storage circuitry responsive to the signals from at least one of the first sensors and the second sensor and to control adjustment of the imaging parameter responsive to the at least one setting, and to generate a message identifying a brand and type of media, and to apply the message to the interface for communication to a host device coupled with the interface to display the brand and the type of media using the host device.

13. A method of forming hard images comprising:
moving media along a media path of an image forming device;
forming hard images upon the media using the image forming device;
retrieving encoded data from the media using the image forming device; and
performing at least one function with respect to the media using the image forming device responsive to the encoded data.

14. The method in accordance with claim 13 wherein the retrieving comprises retrieving the encoded data from the media comprising a plurality of discrete sheets.

15. The method in accordance with claim 13 wherein the forming comprises forming according to at least one imaging parameter, and the performing the at least one function comprises adjusting the imaging parameter.

16. The method in accordance with claim 15 further comprising monitoring at least one ambient condition within the environment of the image forming device, and wherein the adjusting is further responsive to the monitoring.

17. The method in accordance with claim 15 further comprising:
storing a plurality of initial settings for the imaging parameter and corresponding to a plurality of media types;
replacing the initial settings with updated settings at a subsequent moment in time; and
accessing at least one of the initial settings and the updated settings responsive to the encoded data identifying the media to control the adjusting.

18. The method in accordance with claim 13 wherein the performing the at least one function comprises communicating a message identifying the media to a host device.

19. The method in accordance with claim 13 wherein the performing the at least one function comprises communicating a message identifying the media by brand and type for display using a host device.

20. The method in accordance with claim 13 wherein the forming hard images comprises printing.
